(19) United States
(12) Patent Application Publication
(10) Pub. No.: US 2010/0090942 A1
(43) Pub. Date: Apr. 15, 2010

(54) ACTIVE MATRIX DISPLAY DEVICE

(75) Inventor: Naoki SUMI, Hyogo (JP)

Correspondence Address: LOWE HAUPTMAN HAM & BERNER, LLP, 1700 DIAGONAL ROAD, SUITE 300, ALEXANDRIA, VA, 22314, US

(73) Assignee: TPO DISPLAYS CORP., Miao-Li County (TW)

(21) Appl. No.: 12/575,509

(22) Filed: Oct. 8, 2009

(30) Foreign Application Priority Data
Oct. 10, 2008 (JP) 2008-263459

(51) Int. Cl. G09G 3/36

(52) U.S. Cl. 345/102

(57) ABSTRACT

An active matrix display device includes a pixel array consisting of multiple pixels, a backlight source, multiple optical shutters corresponding to respective pixels, a shutter control unit, a light source control unit, and a synchronization control unit. The backlight source is used for illuminating the pixels, thereby displaying an image comprising multiple frames. The shutter control unit is used for switching on/off the optical shutters. The light source control unit is used for modulating the intensity of the light beam emitted by the backlight source at two or more stages. The synchronization control unit is used for synchronizing the modulation of the intensity of the light beam emitted by the backlight source with the on/off statuses of the optical shutters, thereby implementing specified level performance in a specified frame.

### FIELD OF THE INVENTION

The present invention relates to an active matrix display device, and more particularly to an active matrix display device including a pixel array consisting of multiple pixels and a backlight source for illuminating the pixels, thereby displaying an image including multiple frames.

### BACKGROUND OF THE INVENTION

An optical shutter is a two-state device used to rapidly open and close a light path. By switching on/off the optical shutter, the light beams emitted by the backlight source of a display device are controlled to illuminate or not. Recently, as an MEMS (micro-electro-mechanical systems) technology is increasingly developed, the optical shutter is disposed on a thin film transistor (TFT) substrate of a MEMS display according to an MEMS technology.

For example, a method for controlling the optical shutters of a MEMS display device has been discussed by Dan Van Ostrand and B. Tod Cox, “Time Multiplexed Optical Shutter (TMOS)—Advantages & Advances”, in SID Symposium Digest of Technical Papers, 2008, pp. 1054-1057. During a frame cycle, the R, G and B LED lamps of the backlight module sequentially illuminate. In the sub-frame time of each primary color (i.e. red, green or blue), the level performance of a display device is determined according to the on duration of the optical shutter.

FIG. 5 is a schematic timing diagram illustrating the level performance of a display device having optical shutters according to the prior art. During each sub-frame duration, the intensity of the light beam emitted by the backlight source is kept unchanged. As shown in FIG. 5, a sub-frame is divided into eight sub-units. The on durations of the optical shutters for these eight sub-units are modulated at a ratio of 1:2:4:8:16:32:64:128. As such, the display device could exhibit 256 color levels. FIG. 5 is illustrated by sequentially turning on the R, G and B LED lamps of the backlight module during a sub-frame duration. In other words, the color levels could be obtained by alternately switching on/off the optical shutter in a frame.

The above method for controlling the optical shutters, however, still has some drawbacks. For example, a relative high frequency is necessary to drive the optical shutter. As the driving frequency is increased, the power consumption is increased. In addition, the high frequency may result in components degradation, heat generation or breakdown of the display device.

### SUMMARY OF THE INVENTION

The present invention provides an active matrix display device having optical shutters corresponding to respective pixels in order to reduce the driving frequency of the optical shutters.

The present invention also provides an active matrix display device having reduced driving frequency, thereby obviating the problems of causing components degradation, heat generation or breakdown of the display device.

The present invention also provides an active matrix display device so as to obviate the problems of causing response loss and uncomfortable flicker of the backlight source.

In accordance with an aspect of the present invention, there is provided an active matrix display device. The active matrix display device includes a pixel array consisting of multiple pixels, a backlight source, multiple optical shutters corresponding to respective pixels, a shutter control unit, a light source control unit, and a synchronization control unit. The backlight source is used for illuminating the pixels, thereby displaying an image comprising multiple frames. The shutter control unit is used for switching on/off the optical shutters. The light source control unit is used for modulating the intensity of the light beam emitted by the backlight source at two or more stages. The synchronization control unit is used for synchronizing the modulation of the intensity of the light beam emitted by the backlight source with the on/off statuses of the optical shutters, thereby implementing specified level performance in a specified frame.

In an embodiment, the light source control unit modulates the intensity of the light beam emitted by the backlight source at M stages in the specified frame, and the shutter control unit adjusts the on durations of the optical shutters at N stages in the specified frame, so that the active matrix display device exhibits M×N-bit gray level performance in the specified frame, wherein M and N are integers equal to or greater than two, and the synchronization control unit synchronizes the shutter control unit and the light source control unit by controlling the on duration ratio (Aₓ) of the optical shutters and the intensity ratio (I_{y}) of the light beam emitted by the backlight source according to the following equations:

Aₛ=2^{x} (x=0, 1, . . . , N−1)

I_{y}=2^{yN} (y=0, 1, . . . , M−1)

or

Aₓ=2^{xM} (x=0, 1, . . . , N−1)

I_{y}=2^{y} (y=0, 1, . . . , M−1).

In an embodiment, the synchronization control unit synchronizes the modulation of the intensity of the light beam emitted by the backlight source with the on/off statuses of the optical shutters, so that the shortest time period of maintaining a constant intensity of the light beam emitted by the backlight source under control of the light source control unit is longer than a response time of the backlight source but shorter than or equal to a reciprocal of a frame rate.

In an embodiment, the active matrix display device is a micro-electro-mechanical systems (MEMS) display device or a ferroelectric liquid crystal display device.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a display device according to an embodiment of the present invention;

FIG. 2 is a schematic timing diagram illustrating the level performance of the display device of the present invention in the first example;

FIG. 3 is a table illustrating the possible relationships between the ratio of the on durations of the optical shutters for different sub-frames and the ratio of the backlight luminance values at different stages according to the present invention;

FIG. 4 is a schematic timing diagram illustrating the level performance of the display device of the present invention in the second example; and

FIG. 5 is a schematic timing diagram illustrating the level performance of a display device having optical shutters according to the prior art.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

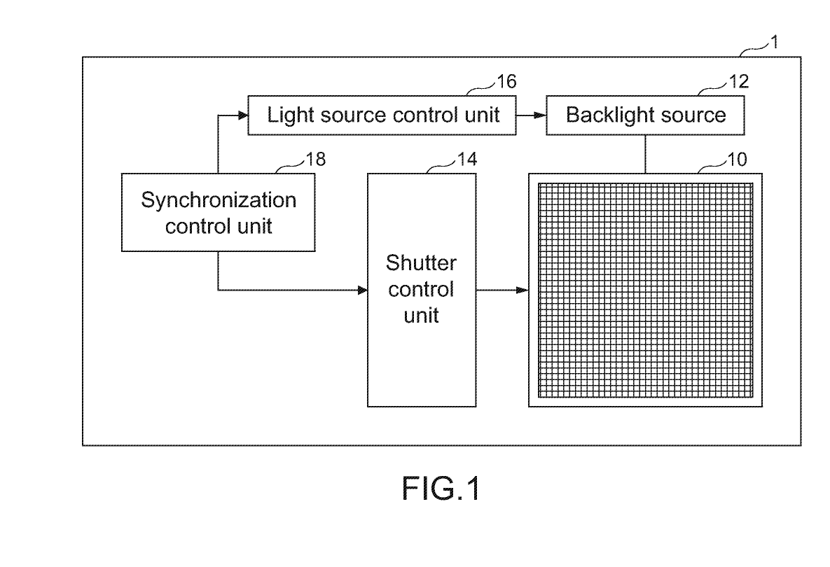

FIG. 1 is a schematic functional block diagram illustrating a display device according to an embodiment of the present invention. As shown in FIG. 1, the display device 1 comprises a pixel array 10 and a backlight source 12. The pixel array 10 consists of multiple pixels. The backlight source 12 is used for illuminating the pixels of the pixel array 10. The display device 1 is an active matrix display for displaying a plurality of frames (i.e. motion pictures). Each pixel corresponds to an optical shutter. By switching on/off the optical shutter, the light beam emitted from the backlight source 12 is penetrative through the pixel or not. The on/off statuses of optical shutter are mechanically or electrically controlled. For example, in a case that the display device 1 is a MEMS display device, the optical shutter is disposed on a thin film transistor (TFT) substrate of the MEMS display according to an MEMS technology, so that the on/off statuses of the optical shutter are mechanically controlled. In another case that the display device 1 is a ferroelectric liquid crystal display device, the liquid crystal alignment of the ferroelectric liquid crystal display device is subject to variation when an electric field is applied thereto, so that the on/off statuses of the optical shutter is electrically controlled.

Please refer to FIG. 1 again. The display device 1 further comprises a shutter control unit 14, a light source control unit 16 and a synchronization control unit 18. Under control of the shutter control unit 14, the optical shutters of respective pixels are switched on/off. By the light source control unit 16, the intensities of the light beams emitted by the backlight source 12 are modulated at two or more stages. The synchronization control unit 18 is used for synchronizing the shutter control unit 14 and the light source control unit 16. Since the on/off statuses of the optical shutter controlled by the shutter control unit 14 and the modulation of light intensities controlled by the light source control unit 16 are synchronized under control of the synchronization control unit 18, a desired color level is achieved according to the on duration of the optical shutter and the light intensity in a specific frame.

Hereinafter, the operation principles of determining the level performance of the display device according to the on duration of the optical shutter and the light intensity will be illustrated in more details with reference to the following examples.

### Example 1

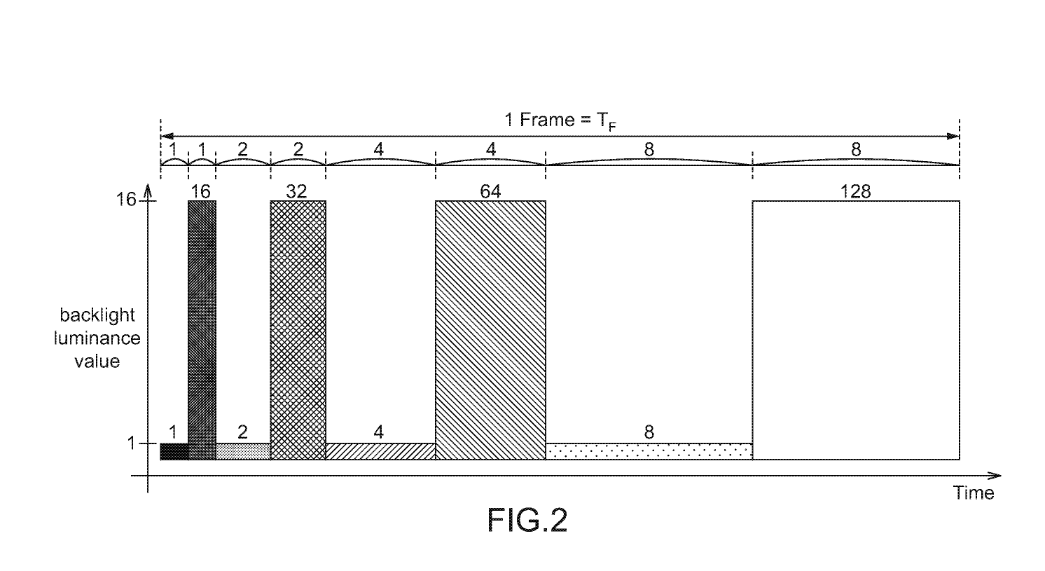

FIG. 2 is a schematic timing diagram illustrating the level performance of the display device of the present invention in the first example. In this example, the display device could display 256 gray levels from full black to full white.

As shown in FIG. 2, a frame duration T_{F} is divided into four sub-frames by the shutter control unit 14. The on durations of the optical shutters for these four sub-frames are modulated at a ratio of 1:2:4:8. In other words, if one frame duration is T_{F}, the on durations of the optical shutters of these four sub-frames are respectively ( 1/15)×T_{F}, ( 2/15)×T_{F}, ( 4/15)×T_{F} and ( 8/15)×T_{F}.

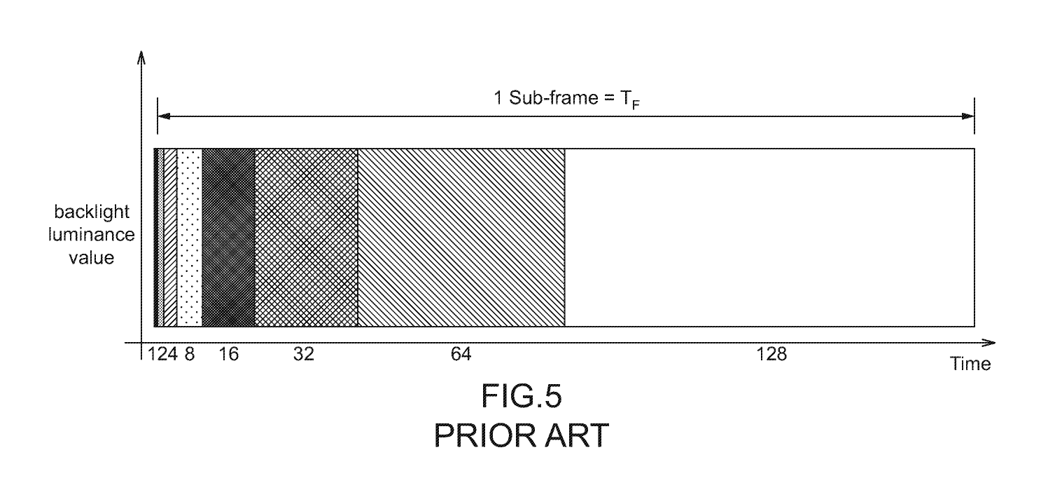

For each sub-frame, the intensities (referred hereinafter as backlight luminance values) of the light beams emitted by the backlight source 12 are modulated at two stages by the light source control unit 16. In this example, the backlight luminance values of these two stages are at a ratio of 1:16. That is, for each sub-frame, the backlight luminance value at the last half interval is sixteen times of that at the first half interval. In comparison with FIG. 5, the backlight luminance values of all sub-frames are not kept unchanged. Whereas, in this embodiment, the backlight luminance values of these two stages are alternately switched at a ratio of 1:16. As shown in FIG. 2, even if the shortest on duration of the optical shutter is equal to a half of the on duration of the first sub-frame, i.e. ( 1/30)×T_{F}, the display device still could exhibit 256 gray levels.

On the other hand, as shown in FIG. 5, the shortest on duration of the optical shutter for the conventional display panel is equal to ( 1/255)×T_{F}. Since the frequency of driving the optical shutter of the present display panel is much lower than that of the conventional display panel, the power consumption is reduced. In addition, the problems of causing components degradation, heat generation or breakdown of the display device will be overcome because the driving frequency is largely reduced.

According to the present invention, the frequency of driving the optical shutter could be reduced by adjusting the ratio of the on durations of the optical shutters for different sub-frames and the ratio of the backlight luminance values at different stages.

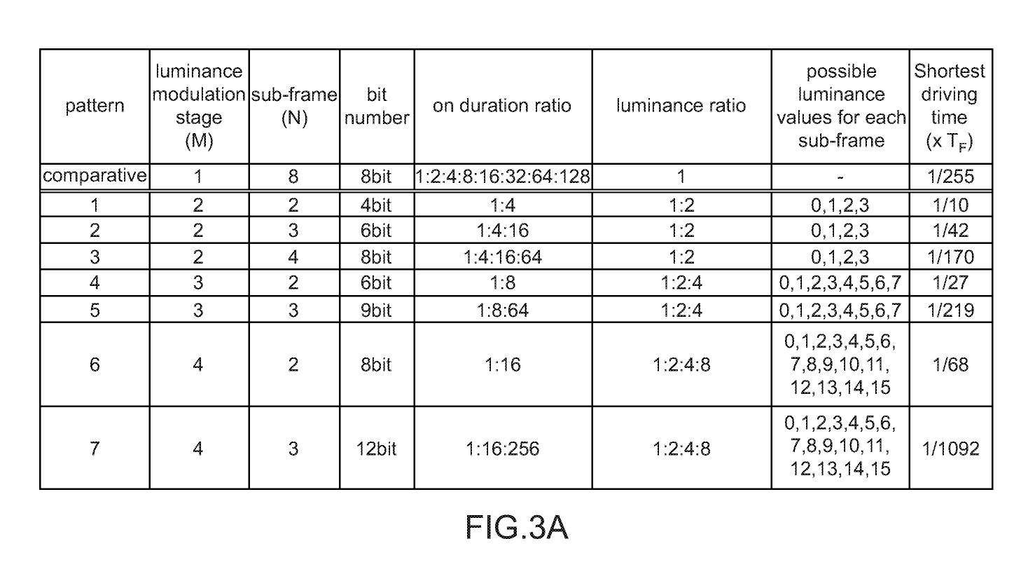

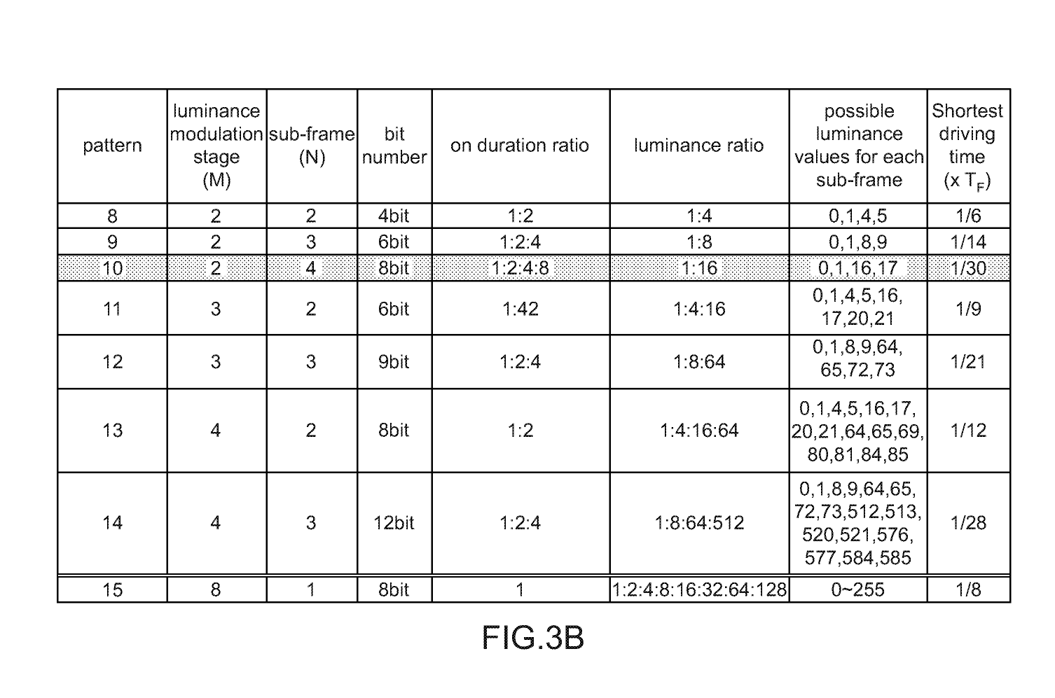

FIG. 3 is a table illustrating the possible relationships between the ratio of the on durations of the optical shutters for different sub-frames and the ratio of the backlight luminance values at different stages according to the present invention.

In the comparative pattern, the backlight luminance value is kept unchanged (M=1), and a frame duration T_{F} is divided into eight sub-frames (N=8). The on durations of the optical shutters for these eight sub-frames are modulated at a ratio of 1:2:4:8:16:32:64:128, and thus the display device could exhibit 256 gray levels (8-bit).

The pattern 10 shows the level performance of the display device as shown in FIG. 2. In the pattern 10, the backlight luminance values are modulated at two stages (M=2), and a specific frame is divided into four sub-frames (N=4). The on durations of the optical shutters for these four sub-frames are modulated at a ratio of 1:2:4:8 and the backlight luminance values of these two stages are at a ratio of 1:16. As such, the display device also exhibits 256 color levels (8-bit). The bit number is equal to the product of the variable stages of the backlight luminance values and the number of the sub-frames (i.e. =M×N).

Please refer to FIGS. 2 and 3 again. Since the backlight luminance values of these two stages are at a ratio of 1:16, four luminance values (i.e. 0, 1, 16 and 17) are possibly obtained for each sub-frame. For example, if the optical shutter at the first half interval and the last half interval is turned off, the luminance value is 0 because the light beam emitted from the backlight source 12 fails to penetrate through the pixel. If the optical shutter at the first half interval is turned on, the luminance value is 1. If the optical shutter at the last half interval is turned on, the luminance value is 16. If the optical shutter at the first half interval and the last half interval is turned on, the luminance value is 17. Moreover, it is also found in the table of FIG. 3 that the shortest on duration of the optical shutter is ( 1/30)×T_{F}.

Assuming that the backlight luminance values are modulated at M stages (M≧2) and the frame duration T_{F} is divided into N sub-frames (N≧2), the synchronization control unit 18 will synchronize the shutter control unit 14 and the light source control unit 16 by controlling the on duration ratio of the optical shutter (A2ₓ) and the backlight luminance value ratio (I2_{y}) according to the following equations:

A2ₓ=2^{x} (x=0, 1, . . . , N−1) (1-1)

I2_{y}=2^{yN} (y=0, 1, . . . , M−1) (1-2)

If the backlight luminance values are modulated at two stages (M=2) and a frame duration T_{F} is divided into four sub-frames (N=4), the on durations of the optical shutter (A2ₓ) are modulated at a ratio of 1:2:4:8 and the backlight luminance values (I2_{y}) are modulated at a ratio of 1:16. The above equations (1-1) and (1-2) are applicable to the patterns 8˜14 (including the pattern 10) in the table of FIG. 3.

In the patterns 1˜7, assuming that the backlight luminance values are modulated at M stages (M≧2) and the frame duration T_{F} is divided into N sub-frames (N≧2), the synchronization control unit 18 will synchronize the shutter control unit 14 and the light source control unit 16 by controlling the on duration ratio of the optical shutter (A1ₓ) and the backlight luminance value ratio (I1_{y}) according to the following equations:

A1ₓ=2^{xM} (x=0, 1, . . . , N−1) (2-1)

I2_{y}=2^{y} (y=0, 1, . . . , M−1) (2-2)

Take the pattern 2 for example. Since the backlight luminance values are modulated at two stages (M=2) and a frame T_{F} is divided into three sub-frames (N=3), the on durations of the optical shutter (A1ₓ) are modulated at a ratio of 1:4:16 and the backlight luminance values (I1_{y}) are modulated at a ratio of 1:2.

In other words, the on durations of the optical shutter and the backlight luminance values for each frame could be combined according to the equations (1-1), (1-2), (2-1) and (2-2).

These equations (1-1), (1-2), (2-1) and (2-2), however, are not applicable to the pattern 15. In the pattern 15, the backlight luminance values are modulated at eight stages (M=8) but the on duration of the optical shutter is kept unchanged (N=1). In other words, the equations (1-1), (1-2), (2-1) and (2-2) are satisfied only when both of M and N are equal to or greater than 2.

### Example 2

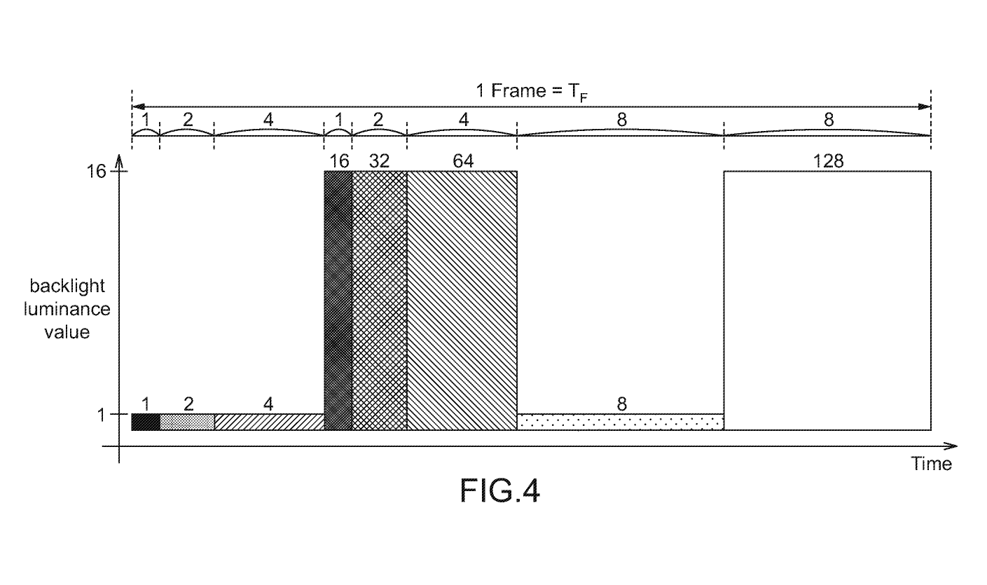

FIG. 4 is a schematic timing diagram illustrating the level performance of the display device of the present invention in the second example. In this example, the display device could display 256 gray levels from full black (level 0) to full white (level 255).

As shown in FIG. 4, a frame duration is divided into eight time intervals by the shutter control unit 14. The on durations of the optical shutters for these eight time intervals are modulated at a ratio of 1:2:4:1:2:4:8:8. In other words, if a frame duration is T_{F}′ the on durations of the optical shutters for these eight time intervals are respectively ( 1/30)×T_{F}, ( 2/30)×T_{F}, ( 4/30)×T_{F}, ( 1/30)×T_{F}, ( 2/30)×T_{F}, ( 4/30)×T_{F}, ( 8/30)×T_{F}, and ( 8/30)×T_{F}.

In this example, the backlight luminance values are modulated at two stages. Under control of the light source control unit 16, the backlight luminance values of these two stages are modulated at a ratio of 1:16. As shown in FIG. 2, the backlight luminance values of these two stages are alternately switched at a ratio of 1:16. Whereas, the backlight luminance values for each of the fourth, fifth, sixth and eighth time intervals is sixteen times of that for each of the first, second, third and seventh time intervals. As shown in FIG. 4, even if the shortest on duration of the optical shutter is equal to ( 1/30)×T_{F}, the display device could exhibit 256 gray levels.

Similarly, the shortest on duration of the optical shutter is equal to ( 1/30)×T_{F}. On the other hand, the shortest time period of maintaining a constant backlight luminance value under control of the light source control unit 16 is equal to the total on duration of the first, second and third time interval or the total on duration of the fourth, fifth and sixth time intervals, i.e. ((1+2+4)/30)×T_{F}. In other words, the shortest time period of maintaining the constant backlight luminance value according to this embodiment is seventh times of that as shown in FIG. 2. Since the shortest time period of maintaining the constant backlight luminance value is prolonged, the problems of causing response loss and uncomfortable flicker of the backlight source 12 will be overcome.

In a case that the backlight source 12 is a LED lamp, the time period for activating the LED lamp is usually 100˜200 ns, which is also referred as a response time. Under control of the light source control unit 16, the shortest time period of maintaining the constant backlight luminance value of the light beam emitted by the backlight source 12 is preferably longer than the response time. On the other hand, if this shortest time period is too long, the driving frequency is too short and thus the problem of causing uncomfortable flicker the backlight source 12 occurs. For preventing occurrence of the uncomfortable flicker, the frequency of modulating the backlight luminance values is larger than or equal to a frame rate. The frame rate is the number of frames that are refreshed per second. In other words, the shortest time period of maintaining the constant backlight luminance value of the light beam emitted by the backlight source 12 is shorter than or equal to a reciprocal of the frame rate.

Since the on/off statuses of the optical shutter controlled by the shutter control unit 14 and the modulation of light intensities controlled by the light source control unit 16 are synchronized under control of the synchronization control unit 18, a desired gray level is achieved according to the on duration of the optical shutter and the light intensity in any frame. As such, the problems of causing the response loss and uncomfortable flicker of the backlight source 12 are obviated.

Like the first embodiment of FIG. 2, in the second embodiment of FIG. 4, the backlight luminance values are modulated at two stages (e.g. 1:16); and the on durations of the optical shutters are modulated at a ratio of 1:2:4:8. Whereas, the allocations of the sub-frame in a frame cycle are distinguished. By combining the on durations of the optical shutter and the backlight luminance values, the driving frequency of the optical shutter is reduced and the problems of causing response loss and uncomfortable flicker of the backlight source 12 are overcome.

The present invention can be applied to successively illuminate R, G and B LED lamps of a backlight source in a frame cycle. The level performance of the active matrix display device for the R, G and B LED lamps in respective sub-frames are similar to that illustrated in FIGS. 2˜4, and is not redundantly described herein.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An active matrix display device comprising:
a pixel array consisting of multiple pixels;
a backlight source for illuminating the pixels, thereby displaying an image comprising multiple frames;
multiple optical shutters corresponding to respective pixels;
a shutter control unit for switching on/off the optical shutters;
a light source control unit for modulating the intensity of the light beam emitted by the backlight source at two or more stages; and
a synchronization control unit for synchronizing the modulation of the intensity of the light beam emitted by the backlight source with the on/off statuses of the optical shutters, thereby implementing specified level performance in a specified frame.

2. The active matrix display device according to claim 1 wherein the light source control unit modulates the intensity of the light beam emitted by the backlight source at M stages in the specified frame, and the shutter control unit adjusts the on durations of the optical shutters at N stages in the specified frame, so that the active matrix display device exhibits M×N-bit gray level performance in the specified frame, wherein M and N are integers equal to or greater than two, and the synchronization control unit synchronizes the shutter control unit and the light source control unit by controlling the on duration ratio (Aₛ) of the optical shutters and the intensity ratio (I_{y}) of the light beam emitted by the backlight source according to the following equations:
Aₛ=2^{x} (x=0, 1, . . . , N−1)
I_{y}=2^{yN} (y=0, 1, . . . , M−1)
or
Aₓ=2^{xM} (x=0, 1, . . . , N−1)
I_{y}=2^{y} (y=0, 1, . . . , M−1).

3. The active matrix display device according to claim 2 wherein the synchronization control unit synchronizes the modulation of the intensity of the light beam emitted by the backlight source with the on/off statuses of the optical shutters, so that the shortest time period of maintaining a constant intensity of the light beam emitted by the backlight source under control of the light source control unit is longer than a response time of the backlight source but shorter than or equal to a reciprocal of a frame rate

4. The active matrix display device according to claim 1 wherein the synchronization control unit synchronizes the modulation of the intensity of the light beam emitted by the backlight source with the on/off statuses of the optical shutters, so that the shortest time period of maintaining a constant intensity of the light beam emitted by the backlight source under control of the light source control unit is longer than a response time of the backlight source but shorter than or equal to a reciprocal of a frame rate.

5. The active matrix display device according to claim 1 wherein the active matrix display device is a micro-electro-mechanical systems (MEMS) display device or a ferroelectric liquid crystal display device.
